(19) United States
(12) Patent Application Publication
(10) Pub. No.: US 2025/0165804 A1
(43) Pub. Date: May 22, 2025

(54) METHOD AND APPARATUS WITH PREDICTION OF TRAINING TIME OF NEURAL NETWORK MODEL

(71) Applicants: SAMSUNG ELECTRONICS CO., LTD., Suwon-si Gyeonggi-do (KR); Korea Advanced Institute of Science and Technology, Daejeon (KR)

(72) Inventors: Minsoo Rhu, Daejeon (KR); Jehyeon Bang, Daejeon (KR)

(21) Appl. No.: 18/945,888

(22) Filed: Nov. 13, 2024

(30) Foreign Application Priority Data
Nov. 22, 2023 (KR) 10-2023-0163714

(51) Int. Cl. G06N 3/098; G06N 3/042; G06N 3/045

(52) U.S. Cl. CPC G06N 3/098; G06N 3/042; G06N 3/045

(57) ABSTRACT

Disclosed is a method and apparatus for predicting a training time. The method includes generating a first execution graph representing a distributed learning process of a neural network model, wherein the first execution graph includes a computation node representing a repeated computation of the neural network model based on a parallelism technique; generating a second execution graph based on the first execution graph and a target operator corresponding to the computation node, wherein the second execution graph includes an execution time of a hardware kernel performing the target operator; and predicting a training time of the neural network model based on the second execution graph.

### CROSS-REFERENCE TO RELATED APPLICATIONS

This application is based on and claims priority under 35 USC § 119 (a) to Korean Patent Application No. 10-2023-0163714 filed on Nov. 22, 2023, in the Korean Intellectual Property Office, the disclosure of which is incorporated by reference herein in its entirety.

### BACKGROUND

### 1. Field

The present disclosure relates to a method and apparatus for predicting a training time of a neural network model.

### 2. Description of Related Art

The rapid advancement of artificial intelligence and machine learning has led to the widespread adoption of neural networks in various applications, from image recognition to natural language processing. Training the neural networks, particularly deep learning models, is computationally intensive and time-consuming. The training process involves iteratively adjusting model parameters to minimize the error between the predicted and actual outcomes, requiring significant computational resources and time.

However, as neural network models grow in complexity and size, accurately predicting the training time becomes critical for efficient resource allocation and planning. Existing systems for predicting the time often fail to predict the training time of the neural network models, considering the multiple parameters involved. Therefore, there is a need in the art for systems and methods that can accurately predict the training time for a neural network model.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

The present disclosure describes systems and methods for predicting a training time of a neural network model. Embodiments of the present disclosure include a method for performing a plurality of computations and simulating a time for training the neural network model. In some cases, the training time may be simulated to reduce a profiling overhead, especially in case of a large neural network model. According to an embodiment, a prediction apparatus of the present disclosure includes a first execution graph generated based on an input information and a parallelism technique. In some cases, the prediction apparatus generates a second execution graph based on the first execution graph and an operator selected based on a distributed learning process. In some cases, a training time of the neural network may be predicted based on the second execution graph.

In one aspect, a method of predicting a training time includes: generating a first execution graph representing a distributed learning process of a neural network model, wherein the first execution graph includes a computation node representing a repeated computation of the neural network model based on a parallelism technique; generating a second execution graph based on the first execution graph and a target operator corresponding to the computation node, wherein the second execution graph includes an execution time of a hardware kernel performing the target operator; and predicting a training time of the neural network model based on the second execution graph.

The first execution graph may include a plurality of computation nodes and a plurality of communication nodes for the distributed learning process.

The generating of the first execution graph comprises dividing a computation task of the neural network model based on the parallelism technique to obtain the plurality of computation nodes.

The generating of the first execution graph comprises identifying a communication pattern based on the parallelism technique and deriving a dependency among the plurality of computation nodes and the plurality of communication nodes based on the communication pattern, wherein an edge of the first execution graph represents the dependency.

The first execution graph is based on a plurality of independent dimensions corresponding to a plurality of parallelism techniques, respectively.

The method further comprises determining a communication pattern based on a structure of the neural network model, the available parallelism technique and a configuration of a hardware device to be used in the distributed learning process, wherein the first execution graphs is based on the communication patterns.

The method further comprises determining a dependency between one or more computation nodes and one or more communication nodes based on a time point at which a communication task occurs in the communication pattern, wherein the first execution graph includes an edge representing the dependency.

The predicting of the training time may include: selecting the target operator to be profiled; and predicting an execution time of the target operator by a profiling module.

The selecting of the target operator may include: selecting a repeated layer in the neural network model; dividing computations in the repeated layer according to the parallelism technique to obtain the repeated computation; and selecting the target operator based on the repeated computation.

The method further comprises profiling the target operator by a profiling module to obtain an execution time; and predicting the training time based on the second execution graph and the execution time of the target operator.

The generating of the second execution graph may include: collecting information about an execution time and a hardware type of the hardware kernel by profiling the target operator; and converting the first execution graph into the second execution graph by replacing the computation node of the first execution graph with node representing the hardware kernel based on the collected information.

The training time is predicted based on the collected information.

The parallelism technique may include at least one of: a data parallelism technique, a tensor parallelism technique, or a pipeline parallelism technique.

The neural network model may include a transformer-based large-scale language model having a plurality of layers with a same hyperparameter, and each of the plurality of layers may be configured to perform computations divided by a predetermined size in the distributed learning process.

In another aspect, an apparatus for predicting a training time includes: a memory storing a neural network; and at least one processor. The processor may be configured to: generate a first execution graph representing a distributed learning process of the neural network model, wherein the first execution graph includes a computation node representing a repeated computation of the neural network model based on a parallelism technique; generate a second execution graph based on the first execution graph and a target operator corresponding to the computation node, wherein the second execution graph includes an execution time of a hardware kernel performing the target operator; and predict a training time of the neural network model based on the second execution graph.

The first execution graph may include a plurality of computation nodes and a plurality of communication nodes for the distributed learning process.

The at least one processor may be configured to divide a computation task of the neural network model based on the parallelism technique to obtain the plurality of computation nodes.

The at least one processor may be configured to: select the target operator to be profiled and predict an execution time of the target operator by a profiling module.

The at least one processor may be configured to: select a repeated layer in the neural network model; divide computations in the repeated layer according to the parallelism technique to obtain the repeated computation; and select the target operator based on the repeated computation.

Other features and aspects will be apparent from the description, the drawings, and the claims.

### BRIEF DESCRIPTION OF THE DRAWINGS

FIG. 1 is a mimetic diagram illustrating operations in a method of predicting a training time according to one or more example embodiments.

FIG. 2 is a flowchart illustrating a method of predicting a training time according to one or more example embodiments.

FIG. 3 is a flowchart illustrating an example of generating a first execution graph according to one or more example embodiments.

FIG. 4 is a flowchart illustrating an example of generating a first execution graph according to one or more example embodiments.

FIG. 5 is a diagram illustrating an example of a first execution graph representing a communication pattern based on a plurality of parallelism techniques according to one or more example embodiments.

FIG. 6 is a flowchart illustrating an example of predicting a training time of a neural network model according to one or more example embodiments.

FIG. 7 is a flowchart illustrating an example of selecting a target operator according to one or more example embodiments.

FIG. 8 is a flowchart illustrating an example of converting a first execution graph into a second execution graph according to one or more example embodiments.

FIG. 9 is a block diagram illustrating an apparatus for predicting a training time according to one or more example embodiments.

FIG. 10 is a flowchart illustrating an example of predicting a training time of the neural network model according to one or more example embodiments.

FIG. 11 is a flowchart illustrating an example of a method of the prediction apparatus according to one or more example embodiments.

Throughout the drawings and the description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The present disclosure describes a system and method for predicting the training time of neural network models. Embodiments of the present disclosure integrate advanced machine learning techniques to analyze and model the complex interactions between different factors affecting training duration. In some cases, a prediction apparatus may perform a profiling operation and simulate a time for reducing a profiling overhead for large-scale neural network models.

Despite the importance of training time prediction, existing methods often rely on heuristic approaches or oversimplified models that are unable to account for the various factors influencing training duration. For example, such factors may include size of the dataset, model architecture, hardware configuration, optimization algorithms, etc. The lack of precise and reliable prediction methods may result in an inefficient use of computational resources, prolonged development cycles, and increased costs.

Additionally, when distributed learning is performed on a large-scale language model or when the size of a neural network model that is to be trained increases, the number of operations used in the training process increases. As a result, an overhead for directly executing and profiling each operation to predict the training time may increase significantly. Therefore, existing methods are unable to accurately and quickly predict the training time of neural network models, considering the various dynamic and static parameters involved.

By contrast, embodiments of the present disclosure are configured to accurately predict the training time of a large-scale neural network model. In some cases, a prediction apparatus for predicting a training time for the neural network may include performing a distributed learning process based on a combination of parallelism techniques. In some cases, the prediction apparatus may simulate an execution time for a computation node based on an execution graph to predict a training time for the neural network model.

Embodiments of the present disclosure include a method for performing a plurality of computations and simulating a time for training the neural network model. In some cases, the training time may be simulated to reduce a profiling overhead, especially in case of a large neural network model. According to an embodiment, a prediction apparatus of the present disclosure includes a first execution graph generated based on an input information and a second execution graph generated based on the first execution graph and an operator selected based on a distributed learning process. In some cases, a training time of the neural network may be predicted based on the second execution graph.

According to an embodiment, a method may be provided for simulating a communication pattern that is generated from various parallelism techniques and representing the communication pattern as an execution graph. In some cases, an operation (i.e., a computation) may be selected that may be used for profiling among the plurality of operations in the execution graph. Accordingly, by profiling a selected operation among the plurality of operations, embodiments of the present disclosure are able to accurately predict a training time of a large-scale neural network model and reduce profiling overhead.

In some cases, data parallelism may be used to directly execute and profile each operation and simulate a required time to predict the training time of an artificial intelligence (AI) model. In some examples, a pipeline parallelism technique may be performed to derive the communication pattern of the first execution graph. In some cases, a tensor parallelism may be performed by dividing an operand for a computation into a plurality of hardware devices resulting in derivation of the communication pattern.

Embodiments of the present disclosure may be configured to predict a training time. In some cases, a first execution graph may be generated representing a distributed learning process of a neural network model. In some cases, the first execution graph includes a computation node representing a repeated computation of the neural network model based on a parallelism technique. Additionally, the prediction apparatus of the present disclosure may generate a second execution graph based on the first execution graph and a target operator corresponding to the computation node. In some cases, the second execution graph includes an execution time of a hardware kernel performing the target operator. Finally, the prediction apparatus may predict a training time of the neural network model based on the second execution graph.

Additionally, an embodiment of the present disclosure describes a method of a prediction apparatus. In some cases, the prediction apparatus may be configured to obtain information representing a structure of a neural network model. The prediction apparatus then generates a plurality of computation nodes based on dividing an operation of the neural network model into a plurality of repeated computations based on a parallelism technique and a hardware device. In some cases, the prediction apparatus may generate a first execution graph including the plurality of computation nodes based on the structure of the neural network model and the hardware device.

According to an embodiment of the present disclosure, a second execution graph, that includes a node representing the hardware kernel, is generated based on the first execution graph and a hardware kernel of the hardware device. Additionally, the prediction apparatus may profile a target operator of the plurality of computation nodes based on the hardware kernel to obtain an execution time. In some cases, the prediction apparatus may be configured to compute a predicted training time based on the second execution graph and the execution time.

Accordingly, by leveraging hardware performance metrics and model-specific characteristics, embodiments of the present disclosure are able to provide an accurate and reliable prediction of training times. Therefore, embodiments may enable developers and researchers to optimize resource allocation, streamline project timelines, and reduce operational costs. The prediction apparatus of the present disclosure may be easily integrated into existing machine learning workflows, offering a comprehensive solution to a critical challenge in neural network training.

The following structural or functional descriptions of example embodiments are provided to merely describe the example embodiments, and the scope of the example embodiments is not limited to the descriptions provided in the disclosure. Various changes and modifications can be made thereto by those of ordinary skill in the art.

Although terms of “first” or “second” are used to explain various components, the components are not limited to the terms. These terms should be used only to distinguish one component from another component. For example, a “first” component may be referred to as a “second” component, or similarly, and the “second” component may be referred to as the “first” component within the scope of the right according to the concept of the present disclosure.

It will be understood that when a component is referred to as being “connected to” another component, the component can be directly connected or coupled to the other component or intervening components may be present.

As used herein, the singular forms are intended to include the plural forms as well, unless the context clearly indicates otherwise. It should be further understood that the terms “comprises,” “comprising,” “includes,” and/or “including,” when used in this specification, specify the presence of stated features, integers, steps, operations, elements, components or a combination thereof, but do not preclude the presence or addition of one or more other features, integers, steps, operations, elements, components, and/or groups thereof.

Unless otherwise defined herein, all terms used herein including technical or scientific terms have the same meanings as those generally understood by one of ordinary skill in the art. Terms defined in dictionaries generally used should be construed to have meanings matching with contextual meanings in the related art and are not to be construed as an ideal or excessively formal meaning unless otherwise defined herein.

The example embodiments described below may be used to, for example, predict a learning time (also referred to herein as a “training time”) at a data center, and may be applied to neural networks, processors, smartphones, mobile devices, or the like to perform distributed learning for artificial intelligence (AI) operations (also referred to herein as “computation”) and/or high-performance computing (HPC)-based processing by mixing parallelism techniques.

Hereinafter, the example embodiments will be described in detail with reference to the accompanying drawings. When describing the example embodiments with reference to the accompanying drawings, like reference numerals refer to like components, and a repeated description related thereto is omitted.

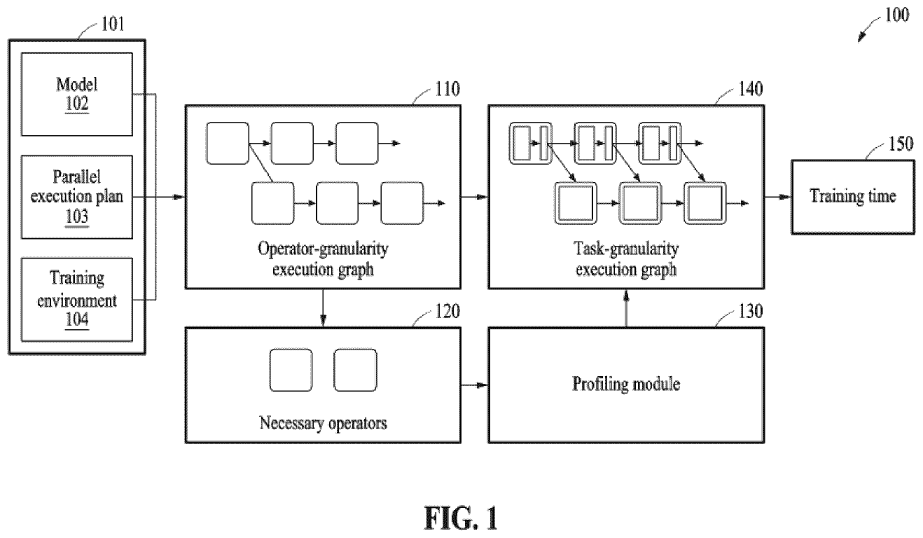

FIG. 1 illustrates operations for predicting a training time according to one or more example embodiments of the present disclosure. FIG. 1 shows a series of operations performed by an apparatus for predicting a training time (hereinafter simply referred to as a “prediction apparatus”) 100 to predict a training time for a neural network model.

For example, the prediction apparatus 100 may represent, as a first execution graph 110, a process of performing distributed learning on a neural network model. In some examples, the neural network model may be a large-scale language model. In some cases, the distributed learning method may include mixing/combining various parallelism techniques and may model, via a profiling module 130, an execution time of each computation node of a second execution graph 140. In some cases, the second execution graph 140 may be obtained by converting the first execution graph 110 to predict a training time 150 required for the learning (also referred to herein as “training”).

As shown in the example of FIG. 1, the prediction apparatus 100 may generate the first execution graph 110 based on input information 101. The input information 101 may include, for example, information 102 related to a model (e.g., a neural network model) for which a training time is to be predicted, information 103 related to an available parallel execution plan (also referred to herein as “parallelism technique”) among a plurality of parallelism techniques, and/or information 104 related to a training environment. However, embodiments may not necessarily be limited thereto.

The information 102 related to a neural network model may include, for example, information about a structure of a neural network model that is (e.g., a target) to be trained. In some cases, information 102 may relate to information about the number of layers included in the neural network model to be trained and an operation (also referred to herein as a “computation”) to be performed in each of the layers. However, embodiments are not necessarily limited thereto.

The information 103 related to an available parallelism technique may include, for example, information about a parallelism technique to be used for distributed learning among various parallelism techniques such as a data parallelism technique, a tensor parallelism technique, a pipeline parallelism technique, etc. In some cases, the parallelism technique may include information about the number of parallelism techniques that may be mixed/combined and used. The information 103 related to an available parallelism technique may change based on the degree of parallelism for distributed learning of a neural network model.

The information 104 related to a training environment may be information related to a hardware device(s) and/or a configuration of the hardware device(s) to be used in a distributed learning process of a neural network model. The information 104 related to a training environment may include, for example, information of a type of hardware device (e.g. a graphics processing unit (GPU), a central processing unit (CPU), a neural processing unit (NPU), a processor for data center, a hardware accelerator, etc.) to be used for distributed learning of a neural network model, the number of hardware devices to be used, and/or the method or manner in which hardware devices in use may be connected or distributed. In some cases, a parallelism technique may determine a difference in GPU utilization and/or training time even in case of the same configuration of hardware devices.

The prediction apparatus 100 may generate the first execution graph 110 by determining information related to an operation (also referred to herein as a “computation”) that may be performed in each hardware device based on the input information 101. The first execution graph 110 may be a graph depicting an execution process of a computational unit. For example, first execution graph 110 may show which computation needs to be performed in each of distributed hardware devices. In some cases, first execution graph 110 may also be referred to as an operator-granularity execution graph.

The prediction apparatus 100 may represent, in the first execution graph 110, a communication pattern generated by each of the plurality of parallelism techniques. For example, during the parallelism of distributed learning for a neural network model, a workload may be distributed to a plurality of hardware devices. Accordingly, when each of the distributed hardware devices completes an assigned computation task, a task of synchronizing computation results between the hardware devices to which a computation task is divided (or distributed) may be performed. The task of synchronizing the computation results of the hardware devices to which the computation task is divided (or distributed) may also be referred to herein as “communication” or a “communication task.”

In some cases, the “communication pattern” described herein may correspond to a pattern that sequentially represents computation tasks and synchronization tasks distributed to a plurality of hardware devices during the parallelism of distributed learning. The communication pattern may be shown differently according to each parallelism technique. In case of distributed learning, communication patterns are the structured methods for data exchange between multiple nodes during the training of machine learning models. Key patterns include synchronous and asynchronous communication, where nodes either synchronize at set intervals or operate independently, respectively. Other patterns involve parameter server architectures for centralized parameter updates, all-reduce for averaging gradients across nodes, and broadcast/scatter for distributing data or model parameters. Efficient communication patterns are essential for optimizing resource utilization, ensuring consistency, and enhancing the scalability and performance of distributed learning systems, enabling effective collaboration and faster convergence in large-scale machine learning tasks.

In some cases, the prediction apparatus 100 may determine a communication pattern shown by each parallelism technique and determine the order and dependency of computations based on the communication pattern to generate the first execution graph 110. In some cases, the first execution graph 110 represents the dependency between the computations. The “dependency between computations” described herein may refer to a temporal dependency or a spatio-temporal dependency between computations distributed and performed in respective hardware devices, for example, indicating an execution order of computations and another computation to be performed after one computation is completed.

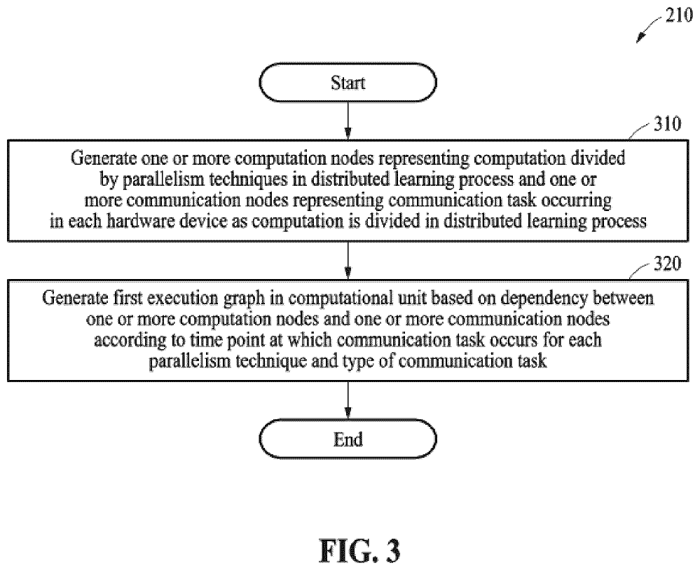

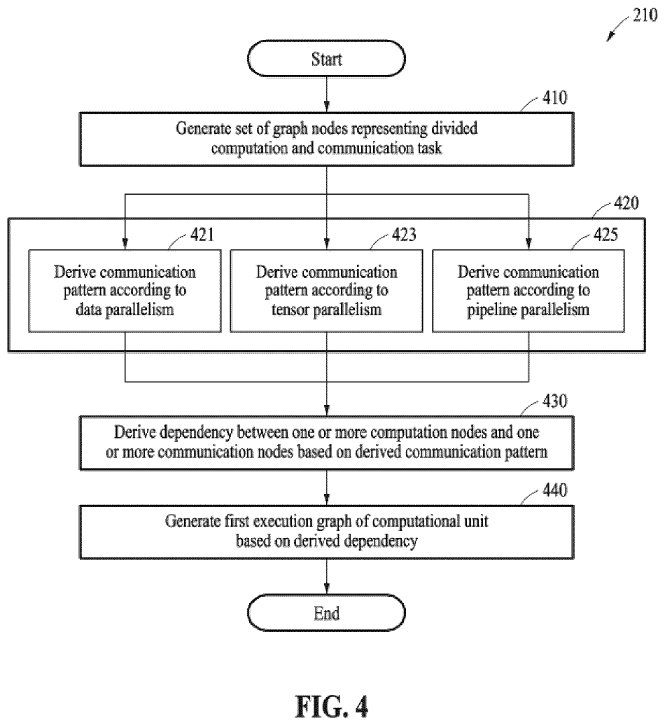

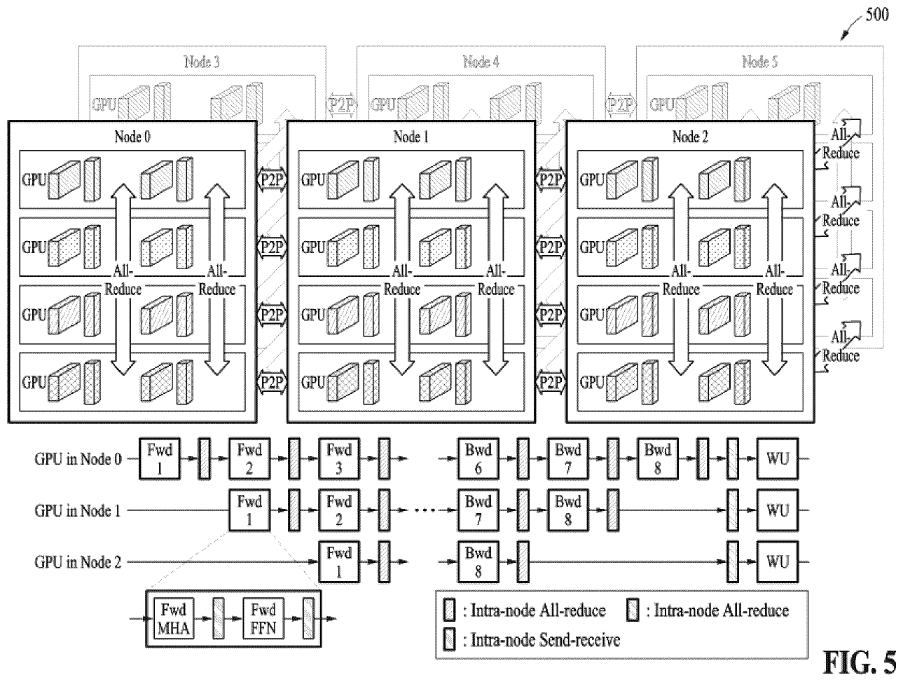

A method by which the prediction apparatus 100 generates a first execution graph (e.g., the first execution graph 110) is described in detail with reference to FIGS. 3 and 4. Additionally, an example of representing, by the prediction apparatus 100, a communication pattern according to various parallelism techniques in a first execution graph (e.g., the first execution graph 110) is described in detail with reference to FIG. 5.

The prediction apparatus 100 may select a target operator 120 based on the first execution graph 110. For example, during a training process of a neural network model such as a transformer-based large-scale language model, the same computation may be performed repeatedly. Considering that the same computation is performed repeatedly, the prediction apparatus 100 may select a computation (or a “target computation”) that may be profiled (e.g., without failure) from among computations performed during the training process of the neural network model.

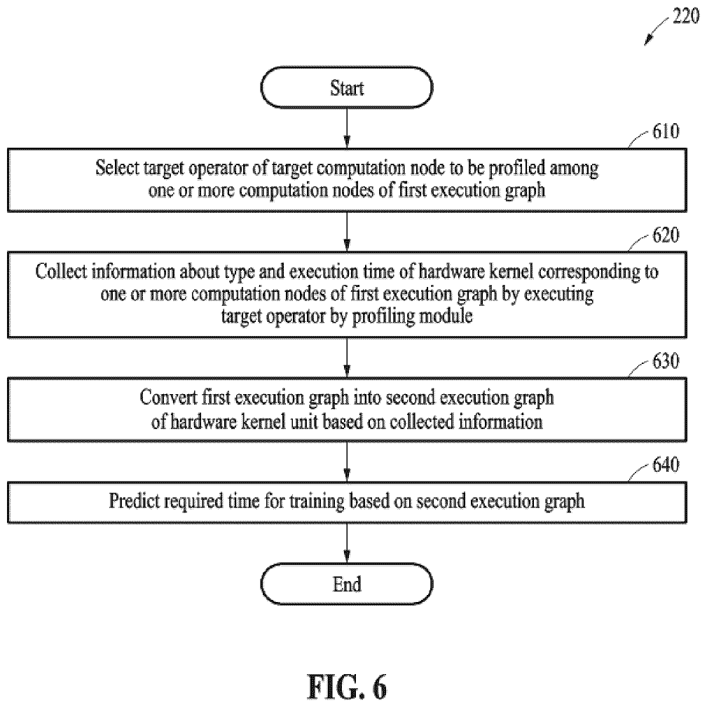

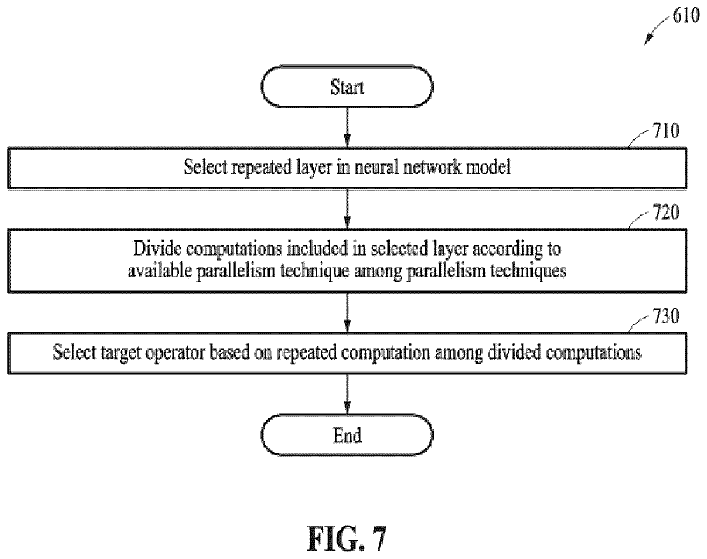

The prediction apparatus 100 may reduce profiling overhead by selecting an operator (or the “target operator” 120) of the target computation required to be profiled from among the computations included in the first execution graph 110. The target operator 120 may also be referred to herein as a “necessary operator” since target operator 120 is an operator required to be profiled without fail to predict a training time. The target operator 120 and a method of selecting a target operator (e.g., the target operator 120) is described in more detail below with reference to FIGS. 6 and 7.

Profiling overhead in neural networks refers to the extra time and computational resources consumed by the process of monitoring and analyzing the performance of a neural network during its execution. Profiling may be used for understanding various performance metrics such as execution time, memory usage, and resource utilization, which enable identification of bottlenecks and optimization of the network. Profiling overhead may include a plurality of aspects, such as execution time overhead, memory usage overhead, resource utilization overhead, and impact on optimization.

The prediction apparatus 100 may select the target operator 120 based on the first execution graph 110 and transmit the selected operator as an input to the profiling module 130. The prediction apparatus 100 may generate a second execution graph 140 by profiling the target operator 120 using the profiling module 130. When the target operator 120 is input, the profiling module 130 may execute the target operator 120 in each hardware device to collect information about a type of hardware kernels executed for the computation of the target operator 120 and/or an execution time of each of the hardware kernels for the computation of the target operator 120. For example, the profiling module 130 may be written using a tool configured to collect information about available hardware.

As used herein, profiling an operator involves analyzing the performance within a computational task to identify inefficiencies and optimize efficiency. Key aspects of profiling may include measuring execution time, memory usage, and resource utilization. Profiling may determine how effectively the operator exploits parallelism, handles data movement, and performs I/O operations. The process involves instrumenting the code to collect performance metrics, analyzing the data to identify inefficiencies, and implementing optimizations. For example, tools such as NVIDIA Nsight for GPU operations and Intel VTune for CPU analysis are commonly employed. Profiling may be used to enhance the performance of specific operations, such as convolution in neural networks, ensuring efficient and effective computation.

The prediction apparatus 100 may generate the second execution graph 140 based on the information collected by the profiling module 130. In some cases, the prediction apparatus 100 may predict the training time 150 for the neural network model based on information related to execution times of graph nodes constituting the second execution graph 140. The second execution graph 140 may be a graph representing a task execution process of a hardware kernel unit, for example, representing the duration for which each distributed hardware device performs the computation of the target operator 120. Additionally, the second execution graph 140 may include information regarding the hardware kernel that may be used for the computation. In some cases, the second execution graph 140 may be referred to as a task-granularity execution graph.

A method by which the prediction apparatus 100 generates a second execution graph (e.g., the second execution graph 140) based on a target operator (e.g., the target operator 120) and predicts a training time (e.g., the training time 150) of a neural network model using the second execution graph is described in detail with reference to FIGS. 6 to 8.

According to an example embodiment, an execution graph (e.g., the first execution graph 110 and the second execution graph 140) may include at least one graph node and an edge among one or more computation nodes and one or more communication nodes.

As used herein, a computation node may correspond to a computation task that is divided and performed during a distributed learning process of a neural network model. The computation node may refer to a node that performs a computation using a hardware operator. In some cases, the computation node may represent a computation divided in the distributed learning process of a neural network model. The computation node may be generated differently depending on which neural network model is to be trained.

A communication node described herein may correspond to a communication task for communication and/or synchronization among hardware devices to which a computation task is divided (or distributed) through a network for distributed learning of a neural network model. The communication node may perform the communication task generated by parallelizing a training process of a neural network model. The communication node may be generated differently depending on the parallelism technique that may used to distribute or divide a computation task in the distributed learning process.

An edge, as described herein, may represent a dependency between graph nodes in an execution graph. In some cases, the execution graph may be a graph with unidirectional edges.

According to an example embodiment, advance prediction of a time required for training (or learning) according to various parallelism techniques and searching for the most effective distributed learning strategy may reduce the cost of training a neural network model.

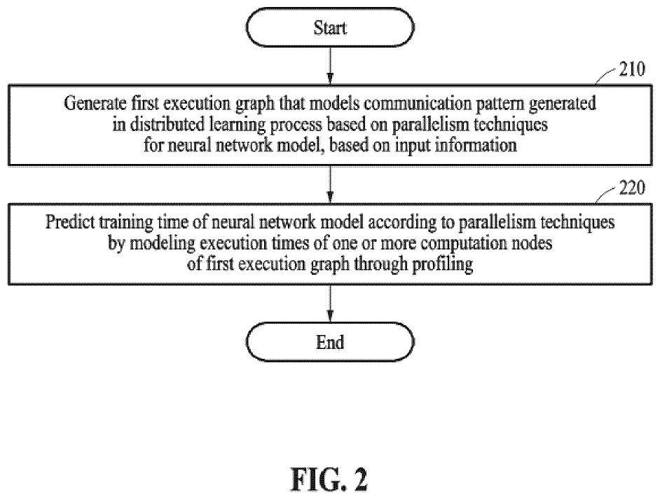

FIG. 2 is a flowchart illustrating a method of predicting a training time according to one or more example embodiments. Operations described below with reference to FIG. 2 and other accompanying drawings may be performed in sequential order but are not necessarily performed in sequential order. For example, the order in which the operations are performed may be changed, at least two operations may be performed in parallel, or one operation may be divided and performed separately. According to an example embodiment, the prediction apparatus may predict a training time of a neural network model through operations 210 and 220.

In operation 210, the prediction apparatus may generate a first execution graph that models a communication pattern shown in a distributed learning process based on a plurality of parallelism techniques for a neural network model, based on input information. In this case, the neural network model may correspond to, for example, a transformer-based large-scale language model.

A transformer-based large-scale language model is an advanced neural network architecture designed for natural language processing tasks. The model uses the transformer architecture, which relies on self-attention mechanisms to capture relationships between words in a sentence, regardless of the word position. The architecture enables efficient parallel processing and better handling of long-range dependencies in text. Large-scale models, often trained on vast datasets, may perform a wide range of tasks such as translation, summarization, and text generation with high accuracy. Examples of such models include, but are not limited to, GPT-3 and BERT, which provide language understanding and generation capabilities.

In some cases, the transformer-based large-scale language model of a structure in which a plurality of layers with the same hyperparameter is repeated but may not be necessarily limited thereto. The plurality of layers may perform computations divided by a predetermined size during the distributed learning process. Accordingly, the prediction apparatus may completely model the entire learning process of the neural network model by profiling divided computations for any one of the layers of the neural network model. A method by which the prediction apparatus generates a first execution graph is described with reference to FIGS. 3 and 4.

The prediction apparatus may represent, in the first execution graph, a communication pattern. For example, the communication pattern is generated by the addition of at least one graph node based on parallelism in the distributed learning process in which a plurality of parallelism techniques may be mixed. In some cases, the communication pattern may represent an independent dimension for each of the plurality of parallelism techniques. The plurality of parallelism techniques may include, for example, a data parallelism technique, a tensor parallelism technique, a pipeline parallelism technique, and the like, but are not necessarily limited thereto.

Data parallelism is a technique where a dataset is divided into mini-datasets, and each micro-batch is processed simultaneously across multiple processors or nodes. In neural network training, each processor trains a replica of the model on different data batches, computing gradients independently. The gradients are then aggregated and averaged to update the model parameters. The approach effectively speeds up training by leveraging parallel computation while maintaining consistent model updates. The data parallelism method is particularly useful in large-scale machine learning tasks, enabling efficient utilization of multiple GPUs or distributed computing resources.

Tensor parallelism is a technique that divides individual tensors (multi-dimensional arrays) within a neural network model across multiple processors or nodes. Instead of replicating the entire model on each processor, tensor parallelism splits large tensors involved in computations, such as weight matrices in layers, across different devices. Each processor performs operations on its portion of the tensor and exchanges necessary information with others to complete the computation. The method enables management of memory usage more efficiently and accelerates computations by distributing the workload, especially in very large models where single-device memory is insufficient.

Pipeline parallelism is a technique where different stages or layers of a neural network model are assigned to different processors or nodes. During training or inference, data flows through these stages in a sequential manner, similar to an assembly line. Each processor performs computations for its assigned layers and then passes the intermediate results to the next processor. By overlapping the execution of different stages, pipeline parallelism improves overall throughput and reduces idle times for processors. The approach is particularly effective for deep neural networks with many layers, enabling efficient scaling and faster processing times.

As described herein, an independent dimension refers to a distinct aspect or component of a computational task that can be parallelized separately from other dimensions. Each independent dimension represents a different way to distribute the workload across multiple processors or nodes without inter-dependencies that may require synchronization or communication between the processors during computation. For example, in case of data parallelism, an independent dimension may refer to different subsets of the dataset. Additionally, in case of the pipeline parallelism, the independent dimension may include different stages of computation. In some examples, in case of tensor parallelism, the independent dimension may refer to different parts of a tensor (such as a sub-tensor that may be handled by a different processor, performing operations, e.g., matrix multiplication, etc., in parallel).

In some cases, even when the prediction apparatus performs distributed learning by mixing/combining the plurality of parallelism techniques, a communication pattern corresponding to each of the parallelism techniques may be generated or may occur independently. Accordingly, the prediction apparatus may derive a communication pattern for each of the plurality of parallelism techniques, combine the derived communication patterns, and apply the combined communication patterns to the first execution graph. An example of representing, by the prediction apparatus, a communication pattern according to various parallelism techniques in a first execution graph is described with reference to FIG. 5.

In operation 220, the prediction apparatus may predict a training time of the neural network model according to the plurality of parallelism techniques by modeling execution times of one or more computation nodes of the first execution graph generated in operation 210 via a profiling process. The prediction apparatus may select a target operator of a target computation node that is required to be profiled from among the one or more computation nodes of the first execution graph. For example, the prediction apparatus may select a repeated layer in the neural network model and may divide computations of the selected layer according to an available parallelism technique among the plurality of parallelism techniques. The prediction apparatus may select the target operator based on repeated computation among the divided computations. Additionally, the prediction apparatus may predict a required time for training based on modeling an execution time of the target operator by a profiling module. For example, the prediction apparatus may convert the first execution graph into a second execution graph in a hardware kernel unit based on a result of profiling the target operator of the target computation node by the profiling module. The prediction apparatus may predict the required time for training based on the second execution graph. A method by which the prediction apparatus predicts a training time of a neural network model is described with reference to FIGS. 6 to 8.

According to an example embodiment, a method of predicting a training time may be applied to a data center that trains a large-scale language model using multiple GPU servers or hardware accelerators.

FIG. 3 is a flowchart illustrating an example of generating a first execution graph according to one or more example embodiments. Referring to FIG. 3, according to an example embodiment, the prediction apparatus may generate a first execution graph through operations 310 and 320.

In operation 310, the prediction apparatus may generate one or more computation nodes representing computations divided by a plurality of parallelism techniques in a distributed learning process, and one or more communication nodes representing a communication task that occurs in each hardware device as the computations are divided in the distributed learning process. The one or more computation nodes and the one or more communication nodes generated in operation 310 may correspond to a set of graph nodes representing the computation task and the communication task, respectively, divided by the plurality of parallelism techniques.

In operation 320, the prediction apparatus may generate a first execution graph in a computational unit based on a time point at which the communication task occurs for each of the plurality of parallelism techniques and a type of communication task. In some cases, the prediction apparatus may generate the first execution graph based on a dependency between the one or more computation nodes and the one or more communication nodes generated in operation 310.

Additionally, based on operation 320, the prediction apparatus may derive a communication pattern for each of the plurality of parallelism techniques. For example, the prediction apparatus may derive the communication pattern for each of the plurality of parallelism techniques based on input information such as information about a structure of a neural network model, an available parallelism technique among the plurality of parallelism techniques, and a configuration of a hardware device to be used in the distributed learning process. The prediction apparatus may derive the dependency between the one or more computation nodes and the one or more communication nodes based on the derived communication pattern. The prediction apparatus may derive the dependency between the one or more computation nodes and the one or more communication nodes according to a time at which the communication task occurs and a type of the communication task based on the derived communication pattern.

The prediction apparatus may generate the first execution graph in a computational unit based on the dependency. The type of the communication task may include, for example, communication patterns for collective communication. The collective communication may correspond to a communication pattern in which multiple processes participate and may also be referred to as “inter-process communication” since the communication is performed between processes. For example, the communication pattern for the collective communication may be a communication pattern of communication in which groups participate, as in a case in which, when there are n processes, a data may be distributed to the n processes and data of the n processes may be collected into one, rather than transmitting data one to one (1:1). The communication pattern of the collective communication may include, for example, a “broadcast” pattern, a “scatter” pattern, a “gather” pattern, and a “reduce” pattern, but is not necessarily limited thereto. In some cases, the broadcast pattern and the scatter pattern may be used to distribute data. In some cases, the gather pattern and the reduce pattern may be used to collect data.

The broadcast pattern may correspond to a pattern in which one process transmits the same copy of data held by the process to a plurality of processes (or nodes) participating in communication. As a result of executing the broadcast pattern, the processes may have the same copy of the data. For example, the broadcast pattern may be used to distribute a global value to multiple processes in a single program multiple data (SPMD) program, and/or transmit a loss value calculated during deep learning in a multi-GPU environment to the plurality of processes. In some cases, the SPMD program may correspond to a computation model for using parallelism in which multiple processors cooperate in the execution of the program to obtain a quick result from multiple data in single program computing.

The scatter pattern may correspond to a pattern in which one process divides data held by the process and transmits the divided parts of the data to the processes by part. As a result of executing the scatter pattern, the processes may have different partial data. The scatter pattern may be used for processes to execute a computation on the data in the SPMD program, that is, is the pattern may be used to perform data parallelism. For example, the scatter pattern may be used to divide N-size mini-batches into equal parts and transmit the mini-batches to GPUs by part during deep learning in the multi-GPU environment. In such a case, each of the GPUs may independently perform a computation (e.g., forward computation) using the received data.

The gather pattern may correspond to a communication pattern in which the processes transmit data held by the processes to one process and gather the data. As a result of executing the gather pattern, the one process may include the data held by the different processes. For example, the gather pattern may be used to gather data held by individual processes in the SPMD program. In some examples, the gather pattern may be used to produce a single result by gathering results (e.g., partial results) processed by the individual processes. In some cases, the gather pattern (i.e., different from the reduce pattern) may refer to a pattern of gathering data, and thus the gather pattern may be used when the results need to be preserved or when a process of computing one result using partial results is difficult to implement in parallel. The gather pattern may be used to calculate a loss value after gathering results processed by the respective (e.g., plurality of) GPUs into one GPU during deep learning in the multi-GPU environment.

The reduce pattern may correspond to a communication pattern in which the processes transmit data held by the processes to one process and generate a single result. As a result of executing the reduce pattern, the one process may include data obtained by a computation using the data held by the processes. For example, the reduce pattern may be used to produce a single result based on gathering results (e.g. partial results) processed by individual processes in the SPMD program.

For example, when three processes (node 1, node 2, and node 3) have partial results a, b, and c, respectively, and node 1 generates a result by applying a function f to the partial results, node 1 may include a result f(a, b, c). In some cases, the function f may enable a parallel computation and may thus be a function that satisfies an associative property. When a computation is performed consecutively two or more times in an expression (or equation), and a result of calculating a preceding computation first is the same as a result of calculating a following computation first, i.e., the computation may satisfy the associative property. For example, functions that satisfy the associative property, such as, for example, “sum,” “max,” “min,” “multiply,” and “and” operations (or computations), may be used as the function f. In some examples, functions that do not satisfy the associative property, such as, a “subtract” operation may not be used as the function f. However, embodiments are not limited thereto, the three processes and three partial results are merely exemplary. As used herein, the number of processes and partial results may be less than or greater than three and each of the number of processes and the number of partial results may be different from each other.

FIG. 4 is a flowchart illustrating an example of generating a first execution graph according to one or more example embodiments. Referring to FIG. 4, according to an example embodiment, the prediction apparatus may generate a first execution graph through operations 410 to 440.

For example, a transformer-based large-scale language model such as GPT-3 may perform distributed learning by mixing/combining various parallelism techniques. When a computation is divided through various parallelism techniques, communication may occur between hardware devices. In this case, a time point at which communication occurs and a type of communication may differ according to each parallelism technique. Thus, the prediction apparatus may generate a first execution graph according to each parallelism technique. The prediction apparatus may generate the first execution graph in the form of, for example, a directed acyclic graph, based on a dependency between graph nodes according to an available parallelism technique.

In operation 410, the prediction apparatus may generate a set of graph nodes representing a computation task and a communication task divided by a plurality of parallelism techniques. The prediction apparatus may identify types of computations generated in a process of training a given neural network model through an input and assign a graph node to each computation to generate the set of graph nodes to be used for computation and communication.

In operation 420, the prediction apparatus may derive a communication pattern for each of the plurality of parallelism techniques. In some cases, the prediction apparatus may derive the communication pattern for each of the plurality of parallelism techniques using the set of graph nodes generated in operation 410. The plurality of parallelism techniques may include but may not necessarily be limited to, for example, a data parallelism technique, a tensor parallelism technique, and a pipeline parallelism technique. In some cases, each parallelism technique may perform parallelism at a different dimension. For example, the data parallelism technique may parallelize input data. The tensor parallelism technique may perform parallelism by dividing an operand for a matrix multiplication into a plurality of hardware devices. The pipeline parallelism technique may parallelize N layers on a layer dimension of the neural network model to different hardware devices in a layer unit. As described, communication and the number and type of hardware devices participating in the communication may vary according to various parallelism techniques.

In operation 421, the prediction apparatus may derive a communication pattern according to the data parallelism technique. In operation 423, the prediction apparatus may derive a communication pattern according to the tensor parallelism technique. For example, in the tensor parallelism technique, an All Reduce communication may be performed between hardware devices (or nodes) after a small matrix multiplication operation is performed twice. In some cases, All Reduce may refer to a task of collecting data (e.g., combining data that may be divided based on multiple devices) into one value through a computation that satisfies an associative property, such as, adding or multiplying data, and copying the resulting value to the devices. Thus, All Reduce may refer to a task of collecting data divided into multiple devices into one value through a computation satisfying the associative property, for example, addition or multiplication, and copying the resulting value to the devices. Accordingly, the prediction apparatus may derive a communication pattern corresponding to a computation task that performs the matrix multiplication operation twice and the All Reduce communication task.

In operation 425, the prediction apparatus may derive a communication pattern according to the pipeline parallelism technique. For example, in case of the pipeline parallelism technique, Send-Receive communication may be performed based on which a result of a computation executed by one hardware device is exchanged with hardware (or nodes) performing another computation. Accordingly, the prediction apparatus may derive a communication pattern corresponding to one computation task that is executed by the hardware device and the Send-Receive communication task that transmits the corresponding computation result to another hardware device.

As described, different types of communication patterns may be derived based on a dimension at which the prediction apparatus divides a workload for distributed learning of the neural network model. The communication pattern may be changed by the addition of a communication node and/or computation node for parallelism, and in such a process of adding a communication node, a dependency may be reflected in the communication pattern.

In operation 430, the prediction apparatus may derive a dependency between the computation node(s) and the communication node(s) based on the communication pattern derived in operation 420. The prediction apparatus may determine the manner in which graph nodes (e.g., the computation node(s) and the communication node(s)) configure the first execution graph. In some examples, the first execution graph may be configured based on dependency on an execution order (e.g., a computation C is performed using a result of a computation A when the computation A is completed) and based on a communication pattern generated by each parallelism technique.

For example, computations in the respective layers of the neural network model may be performed in the following order: computation A→computation B→computation C. In this example, the computation A may be divided into computations a1, a2, a3, and a4, the computation B may be divided into computations b1, b2, b3, and b4, and the computation C may be divided into computations c1, c2, c3, and c4. In this case, in each layer, the computations a1, a2, a3, and a4 may distributed and performed for the computation A, and communication may be performed to synchronize respective results of the computations a1, a2, a3, and a4. Subsequently, after a result of the synchronization of the computations a1, a2, a3, and a4 is received, the computations b1, b2, b3, and b4 for the computation B may be distributed and performed, and communication may be performed to synchronize respective results of the computations b1, b2, b3, and b4. Similarly, for the computation C, distribution and computations may be performed, and communication to synchronize corresponding results may be performed, similar to computation A and computation B. However, embodiments are not limited thereto, the three computations and four divisions are merely exemplary and the number of computations and divisions may be vary. As described, the dependency may refer to a dependency between a computation node and a communication node. In some cases, dependency may refer to dependency between computation nodes.

In operation 440, the prediction apparatus may generate the first execution graph of a computational unit based on the dependency derived in operation 430. As shown in FIG. 4, the first execution graph may be an operator granularity execution graph that represents a training process in a computational unit.

FIG. 5 illustrates an example of a first execution graph representing a communication pattern based on a plurality of parallelism techniques according to one or more example embodiments. Referring to FIG. 5, according to an example embodiment, diagram 500 shows an example of a first execution graph generated to represent a process of training a transformer-based language model on six servers each including four GPUs.

The prediction apparatus may form one pipeline as each of the six servers use a 4-way tensor parallelism technique. Simultaneously, servers 0 to 2 use a 3-way pipeline parallelism technique. Additionally, the prediction apparatus may form a pipeline of the same configuration (i.e., a pipeline formed by the 3-way pipeline parallelism technique) for servers 3 to 5, and parallelize the two pipelines of the servers 0 to 2 and the servers 3 to 5 by a 2-way data parallelism technique.

For example, a 4-way tensor parallelism technique is a method of distributing the computational workload of neural network operations across four processing units, such as GPUs or nodes, by splitting the tensors (multi-dimensional arrays) that represent the model's parameters or intermediate data. In some examples, the tensors in the neural network, such as weight matrices, input data, and intermediate activations, are divided into four smaller sub-tensors. Each sub-tensor is assigned to a different processing unit. In some cases, processing units may exchange intermediate data. After completing local computations, the partial results are aggregated to form the final tensor. In some cases, the model parameters are synchronized across processing units to ensure consistency. The process repeats for each layer of the neural network and for each mini-batch of data until the training or inference is complete.

As used herein, a 3-way pipeline parallelism technique is a method of distributing the workload of a neural network across three different stages or segments, each of which is assigned to a different processor or computing node. The technique helps in parallelizing the execution of a deep learning model, particularly when the model is too large to fit into a single device's memory or for faster training and inference times. In some examples, if a model has 30 layers, the first 10 layers might be assigned to the first segment, the next 10 to the second segment, and the final 10 to the third segment. Each segment runs on a different processor or node. The segments process different mini-batches of data in parallel, with each segment working on a different part of the pipeline simultaneously. Data flows through the segments sequentially which creates a continuous flow of data through the pipeline, with each segment always working on some part of the data. The overlapping of computation increases overall throughput and efficiency.

Additionally, a 2-way data parallelism technique involves splitting a dataset into two parts and processing the split parts in parallel across two computational units, such as processors, GPUs, or nodes. The method may be used in distributed machine learning to enhance computational efficiency and reduce training time. In some cases, the neural network model is replicated across two computational units that processes a subset of data independently. After completion of the processing, the model parameters may be updated synchronously across both units, ensuring that each model replica remains consistent.

According to an embodiment, based on the tensor parallelism technique in each server, intra-node All-Reduce communication may occur at a point at which a multi-head attention (MHA) block and a feed-forward network (FFN) block end. Additionally, when a computation of a layer assigned to each server is completed by the pipeline parallelism technique, inter-node Send-Receive communication may occur to transfer a result of the computation to a subsequent server. In some cases, when backward processing is completed for an input batch provided to each pipeline, inter-node All-Reduce communication may occur to synchronize a weight gradient.

As described herein, communication patterns by various parallelism techniques may be shown at independent dimensions, and thus the prediction apparatus may model the communication patterns independently in the first execution graph as shown in FIG. 5.

As shown at the bottom of FIG. 5, Fwd i and Bwd i described in the communication patterns may indicate forward computation and backward computation of an ith micro-batch, respectively. As described with reference to FIG. 2, a micro-batch may refer to a batch obtained by dividing an input batch into multiple batches of smaller size to perform pipelining computations (or operations) on the input batch.

FIG. 6 is a flowchart illustrating an example of predicting a training time of a neural network model according to one or more example embodiments. Referring to FIG. 6, according to an example embodiment, the prediction apparatus may predict a training time of a neural network model through operations 610 to 640.

In operation 610, the prediction apparatus may select a target operator of a target computation node that is required to be profiled from among one or more computation nodes of a first execution graph. The operation in which the prediction apparatus selects the target operator will be described with reference to FIG. 7.

In operation 620, the prediction apparatus may collect information (or profiling result) about a type and execution time of a hardware kernel corresponding to the one or more computation nodes of the first execution graph by executing the target operator selected in operation 610 using a profiling module. The prediction apparatus may predict a required time for training based on modeling the execution time of the target operator using the profiling module.

For example, the prediction apparatus may profile the target operator of a target computation node using the profiling module. For example, the prediction apparatus may profile information about which hardware kernel may be called for each computation by the target operator and a length of the execution time of the computation. During the profiling, the prediction apparatus may determine information related to a set of hardware kernel nodes with which the graph nodes of the first execution graph representing a dependency of computations may be replaced.

As used herein, hardware kernel nodes refer to the fundamental units of computation within a hardware accelerator or processing architecture, such as those found in GPUs (Graphics Processing Units), TPUs (Tensor Processing Units), or other specialized hardware designed for high-performance computing tasks, including neural network training and inference. The nodes execute “kernels,” which are small, highly optimized functions or programs that perform a specific set of operations on data. In some cases, hardware kernel nodes may be composed of specialized processing units designed to handle operations, such as matrix multiplications, convolutions, or other arithmetic functions commonly used in machine learning and scientific computations.

In operation 630, the prediction apparatus may convert the first execution graph into a second execution graph in a hardware kernel unit based on the information collected in operation 620. Based on the information collected in operation 620, the prediction apparatus may convert the first execution graph into the second execution graph by replacing the one or more computation nodes of the first execution graph with a list of nodes representing the hardware kernel.

In some cases, the prediction apparatus may generate the second execution graph by replacing the computation nodes representing respective computations in the first execution graph with a set of nodes representing hardware kernels. For example, the computation nodes and the hardware kernels may be replaced one-to-one (1:1). The prediction apparatus may perform a task for the computation nodes using information related to a set of hardware kernel nodes with which the graph nodes of the first execution graph are replaced (e.g., determined in operation 620). Therefore, the prediction apparatus may replace each computation with a hardware kernel one-to-one while maintaining a dependency of a computational unit.

In operation 640, the prediction apparatus may predict a required time for training based on the second execution graph obtained in operation 630. The prediction apparatus may predict the required time for training based on information about an execution time of a computation node included in the second execution graph.

FIG. 7 is a flowchart illustrating an example of selecting a target operator according to one or more example embodiments. Referring to FIG. 7, according to an example embodiment, the prediction apparatus may select a target operator using operations 710 to 730.

As the size of a neural network model that is to be trained increases, the number of computations that occur during the training process also increases. In some cases, the cost of profiling may increase in proportion to the size of the neural network model. In some cases, a transformer-based neural network model may include a structure in which multiple layers with the same hyperparameters are repeated. Thus, each layer may be divided into computations of a predetermined size during distributed learning. Therefore, the prediction apparatus may completely simulate the entire training process of the neural network model by profiling only divided computations in a layer.

In operation 710, the prediction apparatus may select a repeated layer in a neural network model. In this case, the neural network model may be a neural network model with the transformer-based model structure. In case of the transformer-based model structure, decoder layers of the same structure may be repeated based on the number of the layers, and therefore the same computation may be repeated. Accordingly, the prediction apparatus may select one layer from among the repeated layers and profile a computation of the selected layer to obtain a profiling result for the remaining layers.

In operation 720, the prediction apparatus may divide computations included in the layer selected in operation 710 according to an available parallelism technique among a plurality of parallelism techniques.

In operation 730, the prediction apparatus may select a target operator based on a repeated computation among the computations divided in operation 720. The prediction apparatus may select the target operator by excluding the repeated computation of the same type and the same size from among the computations divided in operation 720. For example, the prediction apparatus may select the target operator of a target computation node to be profiled by excluding computation nodes corresponding to the repeated computation from among the computation nodes of the first execution graph.

According to an example embodiment, the characteristics of the transformer-based neural network model described herein may be used to select a target operator that is required to be profiled (without fail). The target operator that is required to be profiled (without fail) described herein may correspond to a unit operator that performs repeated computations of the same type and the same size among divided computations.

For example, computation A, computation B, and computation C may be performed in each layer of the neural network model. In this case, the computation A may be divided into computations a1, a2, and a3, the computation B may be divided into computations b1, b2, and b3, and the computation C may be divided into computations c1, c2, and c3. In some cases, computations a1, a2, and a3, computations b1, b2, and b3, and computations c1, c2, and c3 may be computations that perform the same matrix multiplication operation, and the input and output sizes may be the same in each computation. Accordingly, the prediction apparatus may reduce profiling overhead by profiling only a unit operator that performs repeated computations, such as, the computation a1, b2, or c3, i.e., the prediction apparatus may not profile each of the computations A, B, and C. However, embodiments are not limited thereto, the three computations and three divisions are merely exemplary. As used herein, the number of computations and divisions may be less than or greater than three and each of the number of computations and the number of divisions may be different from each other.

Therefore, the prediction apparatus may select, as the target operator, a unit operator that performs repeated computations of the same type and size. In some cases, as used herein, the same type and size may be described in the context of a matrix multiplication operation. In some cases, the computations may be divided in multiple ways. In some cases, the computations of the same type and size may refer to the manner in which the multiplication computation may be divided. For example, in the example illustrated, size of input and output for each of a1, a2, and a3 of computation A may be the same as each other.

In some cases, a large computation may be divided into a plurality of small computations. An embodiment of the present disclosure may be configured to estimate the small computations that may be obtained by dividing a large computation. In some cases, the small computation may be estimated without estimating the large computation. In some cases, as described with reference to the present disclosure, a method of dividing the large computation into a plurality of small computations may be based on the hardware.

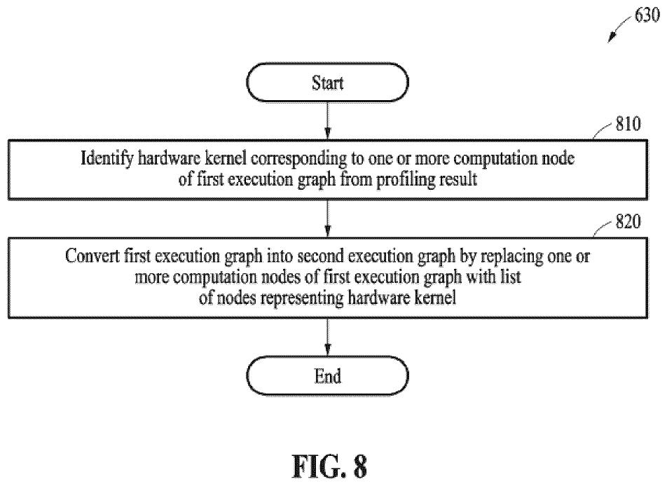

FIG. 8 is a flowchart illustrating an example of converting a first execution graph into a second execution graph according to one or more example embodiments. Referring to FIG. 8, according to an example embodiment, the prediction apparatus may convert a first execution graph into a second execution graph using operations 810 and 820.

In operation 810, the prediction apparatus may identify a hardware kernel corresponding to one or more computation nodes of a first execution graph from a profiling result of a profiling module (e.g., the profiling result in operation 620 in FIG. 6). The prediction apparatus may predict a training time based on simulating an actual training process. In some cases, the prediction apparatus may call a hardware kernel corresponding to each computation node and may use information about an execution time of each hardware kernel. For example, during a profiling of a matrix multiplication operation, one or more hardware kernels that perform the matrix multiplication operation may be called. In some examples, the number of hardware kernels to be called may vary depending on a type of computation. For example, for each type of computation, the prediction apparatus may configure, as a look-up table (LUT), information about hardware kernels used to execute corresponding computations. In some examples, the prediction apparatus may explore the first execution graph from beginning to end to identify information of the corresponding hardware kernel. In this case, different nodes in the LUT may be represented as different hardware kernels.

In operation 820, the prediction apparatus may convert the first execution graph into a second execution graph by replacing one or more computation nodes of the first execution graph with a list of nodes representing the hardware kernel identified in operation 810. The prediction apparatus may replace the computation nodes of the first execution graph with a set of hardware kernels or the list of the nodes representing the hardware kernels to convert the first execution graph into the second execution graph such that the computations are represented as the set of the hardware kernels while maintaining a dependency between the computation nodes. An execution time of each node of the first execution graph may be used to predict a training time. Therefore, the prediction apparatus may profile, on actual hardware, a target operator selected based on the method described with reference to FIG. 7 and may convert the first execution graph into the second execution graph which is a graph of a hardware kernel unit, based on the profiling result.

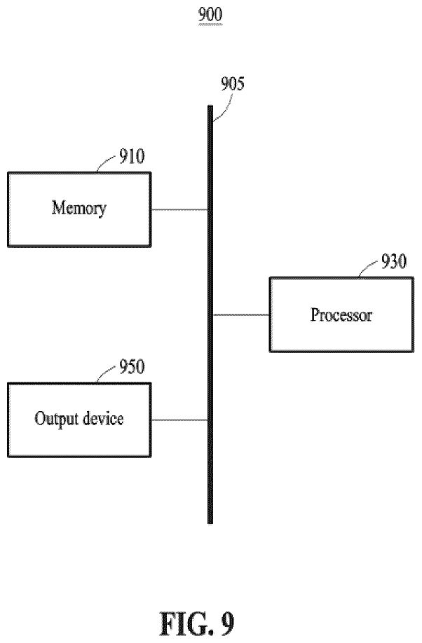

FIG. 9 is a block diagram illustrating an apparatus for predicting a training time according to one or more example embodiments. Referring to FIG. 9, according to an example embodiment, an apparatus 900 for predicting a training time (also referred to herein as prediction apparatus 900) may include a memory 910, a processor 930, and an output device 950. The memory 910, the processor 930, and the output device 950 may be connected to each other through a communication bus 905.

The memory 910 may store a neural network model. In this case, the neural network model may be, for example, a large-scale language model that is trained in advance to perform, for example, a matrix multiplication operation, a convolution operation, an artificial intelligence (AI) operation, and/or high-performance computing (HPC) processing, and the like, but is not necessarily limited thereto.

Additionally, the memory 910 may store various information generated during processing in the processor 930. The memory 910 may also store various data and programs. The memory 910 may include a volatile memory or non-volatile memory. The memory 910 may include a high-capacity storage medium such as a hard disk to store various data.

Memory 910 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor 930 to perform various functions described herein.

In some cases, memory 910 includes a basic input/output system (BIOS) that controls basic hardware or software operations, such as an interaction with peripheral components or devices. In some cases, memory 910 includes a memory controller that operates memory cells of memory 910. For example, the memory controller may include a row decoder, column decoder, or both. In some cases, memory cells within memory 910 store information in the form of a logical state.

A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor 930 is configured to operate a memory array using a memory controller. In other cases, a memory controller is integrated into processor 930. In some cases, processor 930 is configured to execute computer-readable instructions stored in memory 910 to perform various functions. In some aspects, processor 930 includes special purpose components for modem processing, baseband processing, digital signal processing, or transmission processing. According to some aspects, processor 930 comprises the one or more processors described herein.

In some cases, the processor 930 may generate an execution graph that models a communication pattern in a distributed learning process based on a plurality of parallelism techniques for the neural network model stored in the memory 910, based on input information. The processor 930 may predict a training time of the neural network model according to the plurality of parallelism techniques by modeling execution times of one or more computation nodes of the execution graph through profiling. The processor 930 may be provided as one or more processors.

The output device 950 may output the training time of the neural network model predicted by the processor 930. The output device 950 may be, for example, an output interface or a display device. For example, when the output device 950 is a display, the output device 950 may display, on a screen, the training time of the neural network model predicted by the processor 930.

In some cases, output device 950 may be a personal computer, laptop computer, mainframe computer, palmtop computer, personal assistant, mobile device, or any other suitable processing apparatus. In some examples, output device 950 includes software that displays a user interface (e.g., a graphical user interface). In some examples, the user interface may include an audio device, such as an external speaker system, an external display device such as a display screen, or an input device (e.g., a remote-control device interfaced with the user interface). In some cases, the user device user interface may be a graphical user interface.

Additionally, the processor 930 may perform the methods described with reference to FIGS. 1 to 8 or algorithms corresponding to the methods.

The processor 930 may execute a program and control the prediction apparatus 900, and code of the program executed by the processor 930 may be stored in the memory 910.

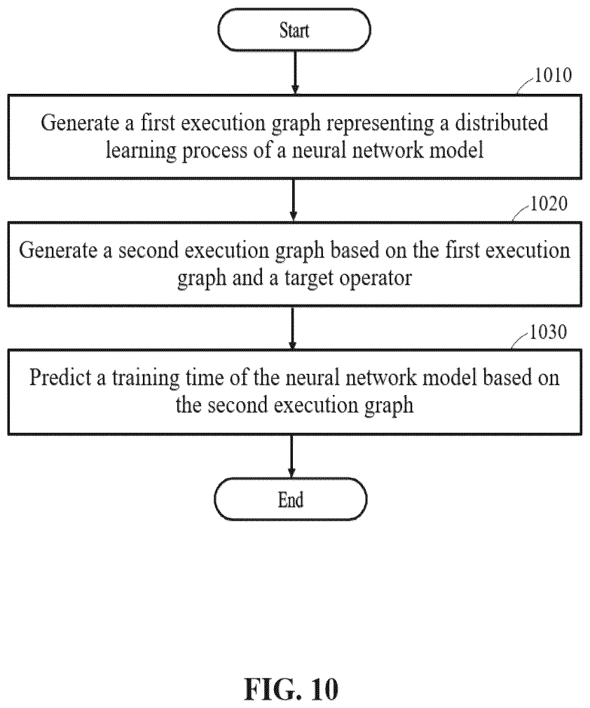

FIG. 10 is a flowchart illustrating an example of predicting a training time of the neural network model according to one or more example embodiments. Referring to FIG. 10, according to an example embodiment, the prediction apparatus may predict a training time for the neural network model through operations 1010 and 1030.

According to an embodiment, the prediction apparatus may generate one or more computation nodes representing computations divided by a plurality of parallelism techniques in a distributed learning process. In some cases, the computation nodes may correspond to a set of graph nodes representing the computation task divided by the plurality of parallelism techniques.

At operation 1010, the prediction apparatus may generate a first execution graph representing a distributed learning process of a neural network model. The first execution graph includes a computation node representing a repeated computation of the neural network model based on a parallelism technique.

In some cases, the first execution graph in a computational unit may be based on a time point at which the communication task occurs for each of the plurality of parallelism techniques and a type of communication task. In some cases, the prediction apparatus may generate the first execution graph based on a dependency between the one or more computation nodes and the one or more communication nodes generated. Further details regarding the generation of the first execution graph are provided with reference to FIG. 3.

Additionally, the prediction apparatus (such as the prediction apparatus shown in FIG. 1) may include a profiling module (such as profiling module 130 in FIG. 1) that profiles a target operator of a computation node based on the hardware kernel that may be called for each computation by the target operator.

At operation 1020, the prediction apparatus generates a second execution graph based on the first execution graph and the target operator corresponding to the computation node. As described, the second execution graph includes an execution time of a hardware kernel performing the target operator. For example, the profiling module may execute the target operator in each hardware device to collect information about a type of hardware kernels executed for the computation of the target operator and/or an execution time of each of the hardware kernels for the computation of the target operator. Further details regarding this step are provided with reference to FIGS. 1 and 7-8.

According to an embodiment, the prediction apparatus, after generating the second execution graph, may predict the training time for the neural network model based on information about execution times of graph nodes constituting the second execution graph. For example, at operation 1030, the prediction apparatus may predict the training time of the neural network model based on the second execution graph.

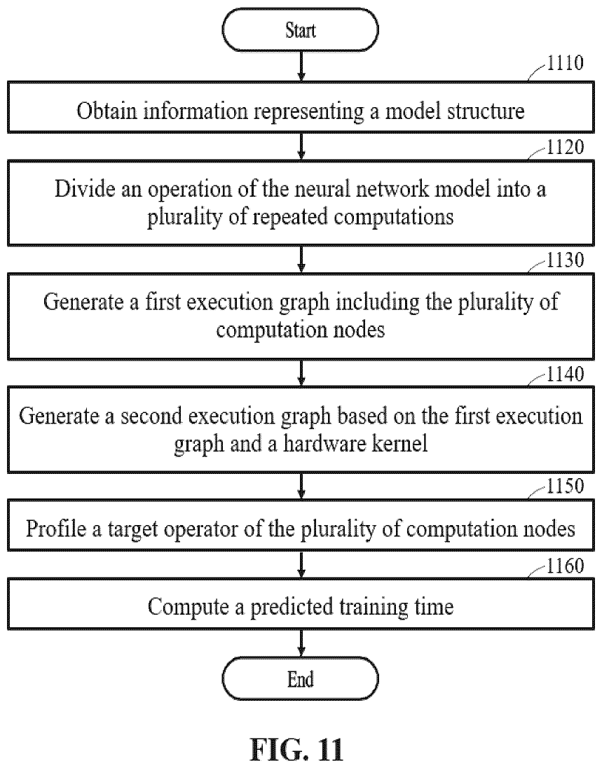

FIG. 11 is a flowchart illustrating an example of a method of the prediction apparatus according to one or more example embodiments. Referring to FIG. 11, according to an example embodiment, the prediction apparatus may compute a predicted training time for the neural network model through operations 1110 and 1160.

At operation 1110, the prediction apparatus may obtain information representing a structure of a neural network model. In some cases, the prediction apparatus obtains input information comprising a structure of the neural network model, an available parallelism technique among the plurality of parallelism techniques, a configuration of a hardware device to be used in the distributed learning process, or a combination thereof. Further details regarding operation 1110 are provided with reference to FIG. 1.

At operation 1120, the prediction apparatus may divide an operation of the neural network model into a plurality of repeated computations. In some cases, the operation may be divided based on a parallelism technique and a hardware device to obtain a plurality of computation nodes. In some cases, a computation node may correspond to a computation task that is divided and performed during a distributed learning process of a neural network model. Further details regarding this step are provided with reference to FIG. 1.

At operation 1130, the prediction apparatus may generate a first execution graph including the plurality of computation nodes based on the structure of the neural network model and the hardware device. In some cases, the prediction apparatus may generate a first execution graph representing a distributed learning process of a neural network model. The first execution graph includes a computation node representing a repeated computation of the neural network model based on a parallelism technique. Further details regarding the generation of the first execution graph are provided with reference to FIG. 3.

Additionally, the prediction apparatus (such as the prediction apparatus shown in FIG. 1) may include a profiling module (such as profiling module 130 in FIG. 1) that profiles a target operator of a computation node based on the hardware kernel that may be called for each computation by the target operator.

Accordingly, at operation 1140, the prediction apparatus generates a second execution graph based on the first execution graph and a hardware kernel of the hardware device. As described, the second execution graph includes a node representing the hardware kernel. Further details regarding this step are provided with reference to FIGS. 1 and 7-8.

At operation 1150, the prediction apparatus may perform profiling of a target operator of the plurality of computation nodes based on the hardware kernel to obtain an execution time. For example, the profiling module may execute the target operator in each hardware device to collect information about a type of hardware kernels executed for the computation of the target operator and/or an execution time of each of the hardware kernels for the computation of the target operator. Further details regarding this step are provided with reference to FIGS. 7-8.

According to an embodiment, the prediction apparatus, after generating the second execution graph, may predict the training time for the neural network model based on information about execution times of graph nodes constituting the second execution graph. At operation 1160, the prediction apparatus may compute a predicted training time based on the second execution graph and the execution time.

The examples described herein may be implemented using hardware components, software components and/or combinations thereof. A processing device may be implemented using one or more general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an OS and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, a processing device may include multiple processors or a processor and a controller. In addition, different processing configurations are possible, such as, parallel processors.

The software may include a computer program, a piece of code, an instruction, or some combination thereof, to independently or collectively instruct or configure the processing device to operate as desired. Software and/or data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described hardware devices may be configured to act as one or more software modules in order to perform the operations of the above-described examples, or vice versa.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

1. A method of predicting a training time, comprising:
generating a first execution graph representing a distributed learning process of a neural network model, wherein the first execution graph includes a computation node representing a repeated computation of the neural network model based on a parallelism technique;
generating a second execution graph based on the first execution graph and a target operator corresponding to the computation node, wherein the second execution graph includes an execution time of a hardware kernel performing the target operator; and
predicting a training time of the neural network model based on the second execution graph.

2. The method of claim 1, wherein the first execution graph comprises a plurality of computation nodes and a plurality of communication nodes for the distributed learning process.

3. The method of claim 2, wherein the generating of the first execution graph comprises:
dividing a computation task of the neural network model based on the parallelism technique to obtain the plurality of computation nodes.

4. The method of claim 2, wherein the generating of the first execution graph comprises:
identifying a communication pattern based on the parallelism technique; and
deriving a dependency among the plurality of computation nodes and the plurality of communication nodes based on the communication pattern, wherein an edge of the first execution graph represents the dependency.

5. The method of claim 1, wherein the first execution graph is based on a plurality of independent dimensions corresponding to a plurality of parallelism techniques, respectively.

6. The method of claim 1, further comprising:
determining a communication pattern based on a structure of the neural network model, the parallelism technique and a configuration of a hardware device to be used in the distributed learning process, wherein the first execution graphs is based on the communication patterns.

7. The method of claim 5, further comprising:
determining a dependency between one or more computation nodes and one or more communication nodes based on a time point at which a communication task occurs in the communication pattern, wherein the first execution graph includes an edge representing the dependency.

8. The method of claim 1, wherein the predicting of the training time comprises:
selecting the target operator to be profiled; and
predicting an execution time of the target operator by a profiling module.

9. The method of claim 8, wherein the selecting of the target operator comprises:
selecting a repeated layer in the neural network model;
dividing computations in the repeated layer according to the parallelism technique to obtain the repeated computation; and
selecting the target operator based on the repeated computation.

10. The method of claim 1, further comprising:
profiling the target operator by a profiling module to obtain an execution time; and
predicting the training time based on the second execution graph and the execution time of the target operator.

11. The method of claim 1, wherein the generating of the second execution graph comprises:
collecting information about an execution time and a hardware type of the hardware kernel by profiling the target operator; and
converting the first execution graph into the second execution graph by replacing the computation node of the first execution graph with a node representing the hardware kernel based on the collected information.

12. The method of claim 11, wherein the training is predicted based on collected information.

13. The method of claim 1, wherein the parallelism technique comprise at least one of:
a data parallelism technique, a tensor parallelism technique, or a pipeline parallelism technique.

14. The method of claim 1, wherein the neural network model comprises a transformer-based large-scale language model having a plurality of layers with a same hyperparameter,
wherein each of the plurality of layers is configured to perform computations divided by a predetermined size in the distributed learning process.

15. A non-transitory computer-readable storage medium storing instructions that, when executed by a processor, cause the processor to perform the method of claim 1.

16. An apparatus for predicting a training time, comprising:
a memory storing a neural network; and
at least one processor configured to: generate a first execution graph representing a distributed learning process of the neural network model, wherein the first execution graph includes a computation node representing a repeated computation of the neural network model based on a parallelism technique; generate a second execution graph based on the first execution graph and a target operator corresponding to the computation node, wherein the second execution graph includes an execution time of a hardware kernel performing the target operator; and predict a training time of the neural network model based on the second execution graph.

17. The apparatus of claim 16, wherein the first execution graph comprises a plurality of computation nodes and a plurality of communication nodes for the distributed learning process.

18. The apparatus of claim 16, wherein the at least one processor is configured to:
divide a computation task of the neural network model based on the parallelism technique to obtain the plurality of computation nodes.

19. The apparatus of claim 16, wherein the at least one processor is configured to:
select the target operator to be profiled; and
predict an execution time of the target operator by a profiling module.

20. The apparatus of claim 19, wherein the at least one processor is configured to:
select a repeated layer in the neural network model;
divide computations in the repeated layer according to the parallelism technique to obtain the repeated computation; and
select the target operator based on the repeated computation.

21. A method comprising:
obtaining information representing a structure of a neural network model;
dividing an operation of the neural network model into a plurality of repeated computations based on a parallelism technique and a hardware device to obtain a plurality of computation nodes;
generating a first execution graph including the plurality of computation nodes based on the structure of the neural network model and the hardware device;
generating a second execution graph based on the first execution graph and a hardware kernel of the hardware device, wherein the second execution graph includes a node representing the hardware kernel;
profiling a target operator of the plurality of computation nodes based on the hardware kernel to obtain an execution time; and
computing a predicted training time based on the second execution graph and the execution time.
